(19) United States
(12) Patent Application Publication
(10) Pub. No.: US 2017/0108591 A1
(43) Pub. Date: Apr. 20, 2017

(54) GAMMA-RAY MEASUREMENT DEVICE AND GAMMA-RAY MEASUREMENT METHOD

(71) Applicants: MITSUBISHI HEAVY INDUSTRIES MECHATRONICS SYSTEMS, LTD., Hyogo (JP); OSAKA UNIVERSITY, Osaka (JP)

(72) Inventors: Shuhei KURI, Hyogo (JP); Toshiharu TAKAHASHI, Hyogo (JP); Hiroshi HORIIKE, Osaka (JP); Eiji HOASHI, Osaka (JP); Isao MURATA, Osaka (JP); Sachiko DOI, Osaka (JP)

(21) Appl. No.: 15/317,113

(22) PCT Filed: Jun. 12, 2015
(86) PCT No.: PCT/JP2015/067047

§ 371 Date: Dec. 7, 2016

(30) Foreign Application Priority Data
Jun. 13, 2014 (JP) 2014-122911

(51) Int. Cl. G01T 1/06; G01T 7/00; G01T 1/161

(52) U.S. Cl. CPC G01T 1/06; G01T 1/161; G01T 7/00

(57) ABSTRACT

Provided are a gamma-ray measurement device and a gamma-ray measurement method which perform a gamma-ray measurement of simple and inexpensive structure in a mixed field of neutrons and gamma-rays. A gamma-ray measurement device is used in a method for measuring the dose in the same place when using a lead filter and when not using the filter, and obtaining a gamma dose from a difference. The gamma-ray measurement device includes a first detector which is made up of the lead filter for shielding gamma-rays and a glass dosimeter disposed in the center of the filter, and a second detector that is made up of only the glass dosimeter.

### FIELD

The present invention relates to a gamma-ray measurement device and a gamma-ray measurement method that measure the dose of gamma-rays in a mixed field of neutrons and gamma-rays.

### BACKGROUND

Currently, a boron neutron capture therapy (BNCT) has attracted attention as a technique that is capable of selectively killing and treating cancer cells. In the BNCT, since it is required to utilize thermal neutrons and epithermal neutrons, there are many restrictions, for example, patients need to visit a nuclear reactor which can generate and utilize neutrons. Thus, a compact neutron generator capable of generating neutrons in hospitals is desired. In the neutron generator, proton and deuteron accelerated in an accelerator are made to collide with target of beryllium or lithium.

As a conventional accelerator, an accelerator described in Non Patent Literature 1 has been known. The accelerator has a configuration in which an ECR (electron cyclotron resonance) type ion source, a radio frequency quadruple linear accelerator (RFQ linac), and a drift tube type linear accelerator (DTL) are continuously provided. In the accelerator, the deuteron ions are accelerated up to 5 MeV by the RFQ linac and are accelerated up to 40 MeV by the DTL. Liquid lithium which flows over a curved back wall is irradiated with beam of the accelerated deuteron ions to generate neutrons behind the liquid lithium.

### CITATION LIST

### Non Patent Literature

Non Patent Literature 1: Summary of International Fusion Materials Irradiation Facility (IFMIF) Plan

Institute for Materials Research, Tohoku University, Japan Atomic Energy Research Institute, Hideki Matsui, 11th Nuclear Fusion Research and Development Problem Study Group, Sep. 29, 2003, page 14

### SUMMARY

### Technical Problem

A neutron irradiation field of BNCT is a mixed field of neutrons and gamma-rays, and a development of a method of separating and measuring the dose of gamma-rays is desired. Further, a device required for a technique for measuring the dose of gamma-rays needs to have a simple and inexpensive configuration, in order to reduce the cost of treatment.

### Solution to Problem

A gamma-ray measurement device of a present invention includes a first detector which is disposed around a radiation dosimeter that is the same as a radiation dosimeter constituting a second detector used together, and is formed of lead or lead alloy. The first detector is made up of a filter in which the thickness is determined such that an attenuation of neutrons and a correction factor of gamma-rays are within an allowable range in the measurement of gamma rays.

In particular, a preferable measurement result can be obtained when the thickness of the filter is 2 cm or less and 1 cm or more in terms of pure lead.

It is preferable that the filter further is a substantially hollow spherical body or a substantially cylindrical body having a uniform thickness in which a glass dosimeter is disposed in a center. It is preferable that the gamma-ray measurement device further includes a support member configured to support the glass dosimeter at a predetermined position therein.

A gamma-ray measurement method of a present invention includes placing one of the above-described first detector, and the second detector made up of the same radiation dosimeter as the radiation dosimeter used in the first detector in a mixed field of neutrons and gamma-ray, and thereafter, estimating the dose of gamma-rays based on the remaining dose as the attenuation of the dose of gamma-rays, by subtracting the dose measured by the radiation dosimeter of the first detector from the dose measured by the radiation dosimeter of the second detector.

### BRIEF DESCRIPTION OF DRAWINGS

FIG. 1A is a cross-sectional view of a first detector of a gamma-ray measurement device according to a first embodiment of the present invention.

FIG. 1B is a plan view of a first detector.

FIG. 1C is a plan view of a second detector.

FIG. 2 is a perspective view from a bottom direction of the first detector illustrated in FIG. 1.

FIG. 3 is a graph illustrating an attenuation ratio of the neutron dose to the neutron energy.

FIG. 4 is a graph illustrating an energy dependence of a correction factor to the thickness of a filter of the gamma-ray dose.

FIG. 5A is a perspective view illustrating a modified example of the first detector.

FIG. 5B is a plan view illustrating a modified example of the first detector.

FIG. 6 is a graph illustrating a subtraction result (Sv value per source) of filter presence or absence for the dose D of mixed field, using a Flat response analysis.

### DESCRIPTION OF EMBODIMENTS

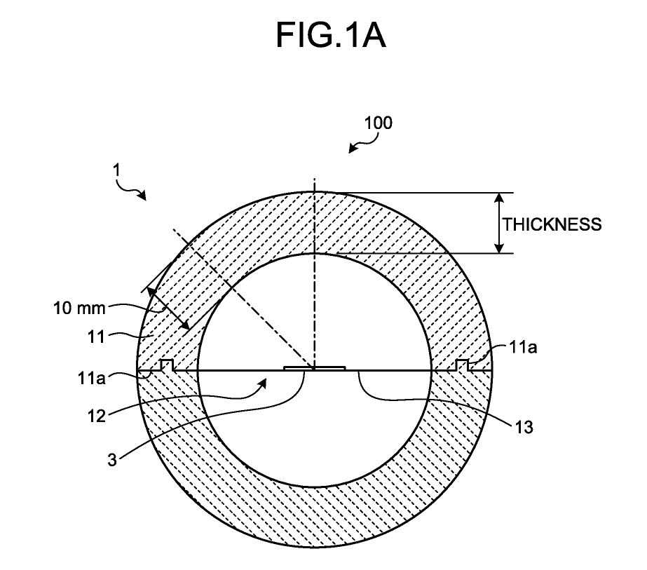

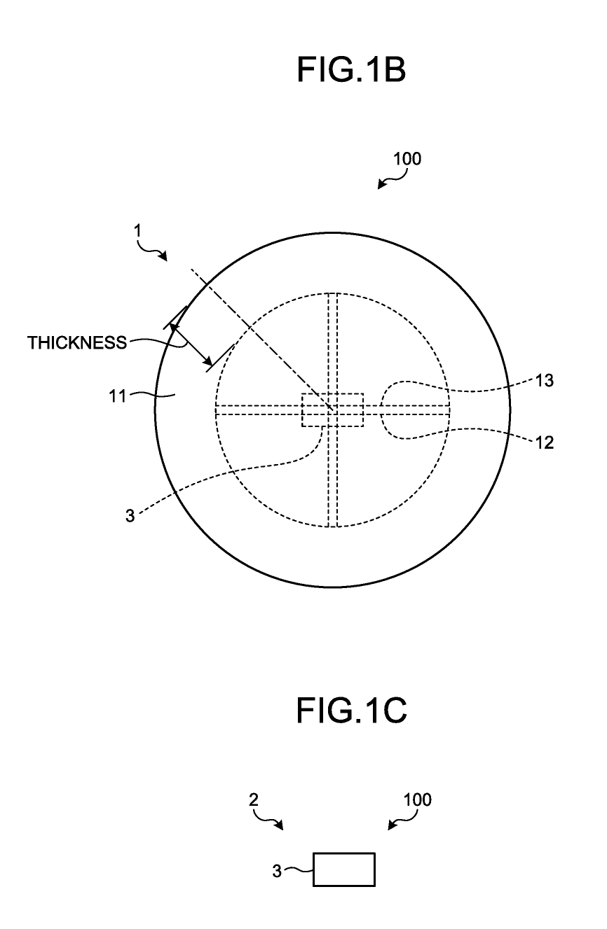

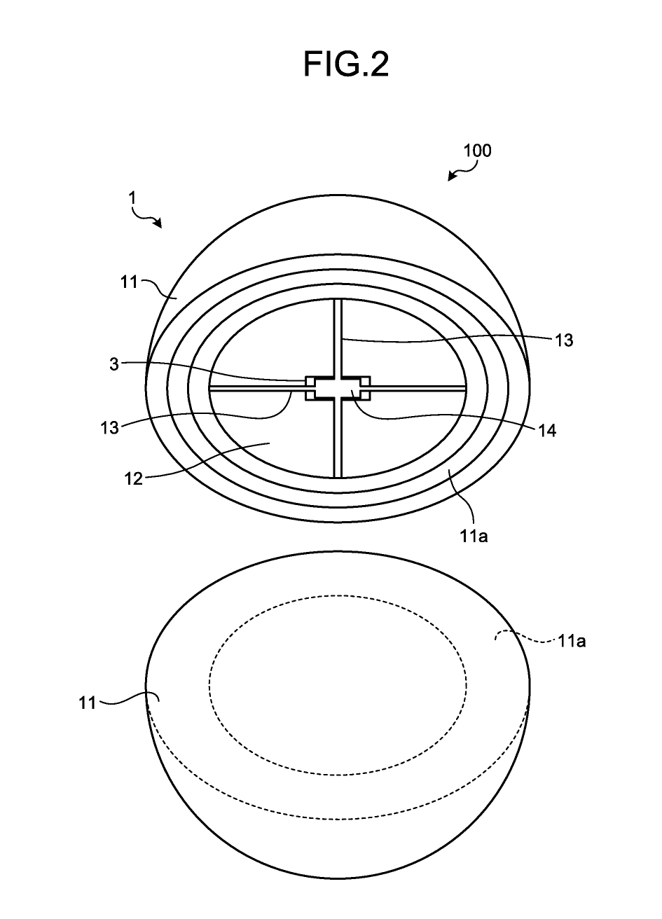

FIGS. 1A to 1C are block diagrams illustrating the respective portions of the gamma-ray measurement device according to a first embodiment of the present invention. FIG. 1A is a cross-sectional view of a first detector. FIG. 1B is a plan view of the first detector. FIG. 1C is a plan view of a second detector. FIG. 2 is a perspective view of the first detector illustrated in FIG. 1 from a bottom direction. A gamma-ray measurement device 100 is used in a method of measuring the dose when using a filter 11 of the lead and when not using the filter in the same place, and obtaining the gamma-ray dose from a difference, and is configured to include a first detector 1 which includes the filter 11 made of lead which shields gamma-rays and a glass dosimeter 3 disposed in the center of the filter 11, and a second detector 2 that includes only the glass dosimeter 3.

The filter 11 is a hollow spherical body of lead casting. Because of easy machining, high shielding capability of the gamma-rays and low attenuation capability of neutrons, lead is used. Lead is a pure lead (more than 99.97%). Further, as long as a required quantity of lead is contained, a lead alloy may be used as the filter 11. Also, since it is possible to eliminate the shape dependence of the dosimeter by creating a uniform field inside, the spherical shape is provided. A divided end surface 11a of the filter 11 has a stepped shape such that gamma-rays and neutrons do not escape in a radial direction from the center, in a state of forming a combined sphere.

The filter 11 can be divided in half, and a support member 12 capable of holding the glass dosimeter 3 is provided in the center of the sphere. The support member 12 includes an arm 13 that extends toward the sphere center from the end surface when dived into a hemisphere every 90 degrees. The glass dosimeter 3 is held in the center of the sphere by the support member 12. The support member 12 is preferably made of a member such as paper or plastic that is easily machined. Also, an adhesive tape or the like is provided in a fixing portion 14 which holds the glass dosimeter 3.

Further, as long as it is possible to hold the glass dosimeter 3 in the sphere center, the support member 12 may have a configuration in which the fixing portion of the glass dosimeter 3, such as an adhesive tape, is provided in a central portion of a planar thin plate made of a material having low characteristics of absorbing neutrons and gamma-rays between the end surfaces of the hemisphere. Further, the support member 12 may have a configuration in which a fixing portion of the glass dosimeter 3 is provided at a tip such that a cantilevered arm extends from the end surface of the hemisphere and the tip is located in the sphere center. Further, the support member 12 may have a wire shape.

As the glass dosimeter 3, one used as a simple (individual) exposure dosimeter on behalf of the TLD is used. The glass dosimeter 3 of the first detector 1 has a flat-plate like rectangular shape. The second detector 2 is made up of the glass dosimeter 3 having the same shape, size and material as those of the glass dosimeter 3 of the first detector 1.

The thickness of the filter 11 is determined to include both properties with good balance such that the shielding capability of the gamma-rays increases and the attenuation capability of the neutrons decreases. In other words, the attenuation of neutrons and the correction factor of the gamma-rays become a thickness that falls within an acceptable range in the measurement of gamma-rays. Next, a method of determining the thickness of the filter 11 will be described.

If a (γ, n) reaction can be ignored, the dose D of a mixed field of neutrons and gamma-rays is as follows:

D=Dn+Dnγ+Dγ (1)

Here, Dn is a direct dose of the neutrons, Dnγ is neutron-induced gamma-ray dose, and Dγ is a direct dose of gamma-rays. The physical quantity to be obtained is Dγ.

The direct dose Dγ of gamma-rays can be basically obtained by the following formula:

Dγ=(D−Dlead)·η (2)

Here, η is a correction factor. Dlead is a measured dose of the glass dosimeter 3 having the filter. Assuming that the neutron dose does not change in the presence or absence of the filter, Dlead is given by the following formula:

Dlead=Dn+Dnγ+ξDγ (3)

Here, ξ is an attenuation ratio of γ-ray. At this time, η has the following relation with the attenuation ratio ξ of the gamma-ray.

η=1/(1−ξ) (4)

Hereinafter, by illustrating study results on the energy dependence of the attenuation ratio of the neutrons, the attenuation ratio of the gamma-rays, and the effect of Dnγ, validity of formulas (2) and (3) is illustrated.

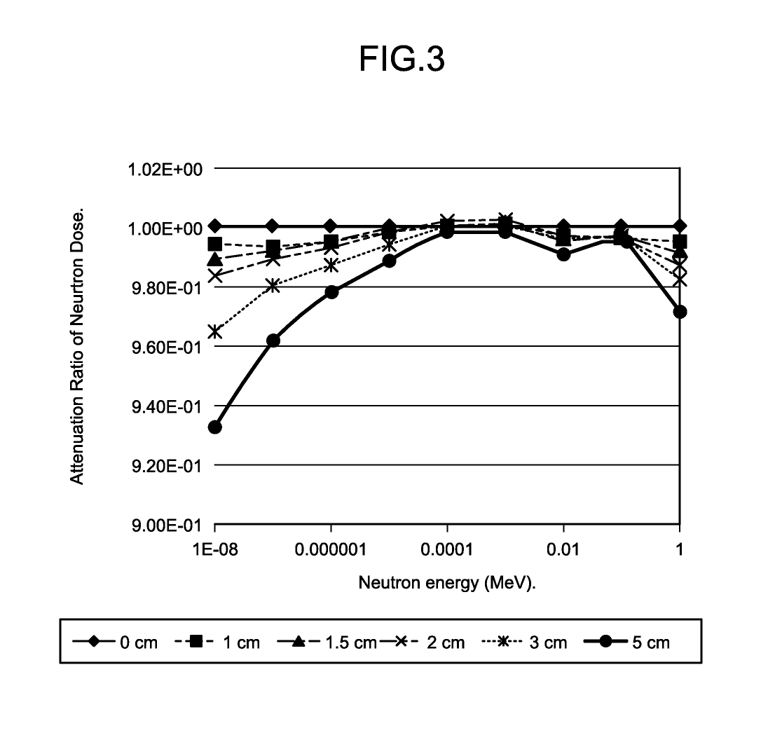

FIG. 3 is a graph illustrating an attenuation ratio of the neutron dose to the neutron energy. A parameter is the thickness of the filter 11. A neutron absorption cross-sectional area of the lead decreases, and its α value (a maximum energy reduction rate due to elastic scattering) exceeds 0.99. Therefore, lead allows to the neutrons to pass through, without reducing the intensity and energy of neutrons. Meanwhile, since lead has the large mass number, an angular dependence of the scattered neutron intensity is small. Thus, as the thickness of the filter 11 increases, the number of neutrons that reach the glass dosimeter 3 decreases. That is, the attenuation capability of the neutrons may be adjusted by the thickness of the filter 11, and for example, the attenuation of neutrons may be sufficiently reduced. This may be achieved only by reducing the thickness of the filter 11. As illustrated in FIG. 3, by setting the thickness of the filter 11 as 1 cm, 1.5 cm, 2 cm, 3 cm and 5 cm to measure the attenuation of each of the neutrons, it was possible to check that the neutron attenuation was decreased with a decrease in the filter thickness. Further, if the thickness of the filter 11 is set to 2 cm or less, it is possible to stably and sufficiently reduce the attenuation of neutrons within a wide energy range.

In formula (2), in the present invention, in a state of shielding the gamma-rays with the filter 11 and not shielding the neutrons, by subtracting the measurement result of the first detector 1 from the measurement result of the second detector 2, the dose of the shielded gamma-rays is obtained. The dose obtained by the first detector 1 and the second detector 2 is expressed using the formula (1) as follows:

First detector Dlead=Dn (lead)+Dnγ (lead)+ξDγ(lead)

Second detector D=Dn+Dnγ+Dγ

Since the value to be obtained is the attenuation quantity of the dose of gamma-rays, the following formula is obtained:

D−Dlead=Dn−Dn (lead)+Dnγ−Dnγ (lead)+Dγ−ξDγ (lead)

As described above, by setting the thickness of the filter 11 to 2 cm or less, the presence or absence of the filter 11 is considered to hardly affect on the measurement of the shielding of neutrons. Thus, Dn (lead)≈Dn is obtained.

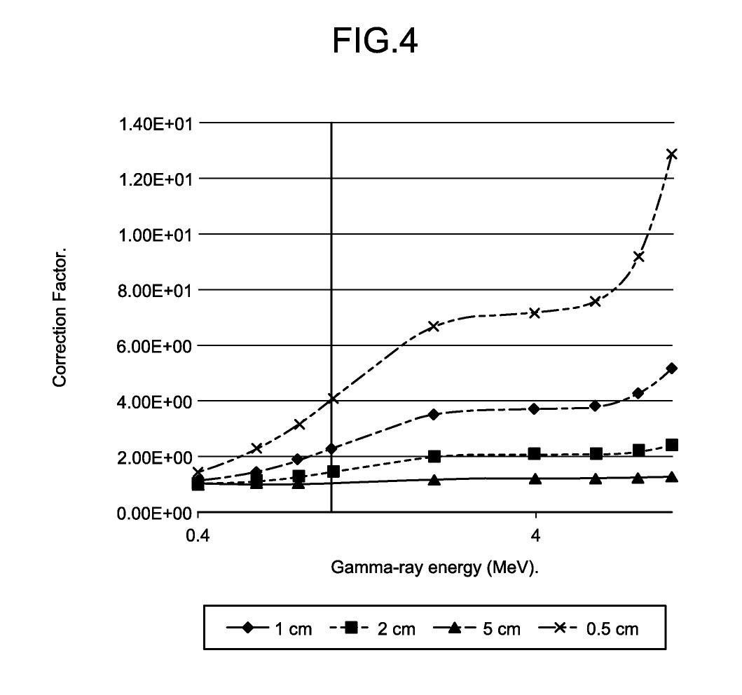

Next, the shielding of the gamma-rays will be considered. FIG. 4 is a graph illustrating the energy dependence of the correction factor for the thickness of the filter of the gamma-ray dose. The correction factor is approximately 1 with the range of the energy of the gamma-rays of 0.4 MeV or less. Further, it is determined that the correction factor approaches 1 and stable within a wide energy range with an increase in the thickness of the filter 11. In order to obtain the low energy dependence and the stable correction factor, the filter thickness is preferably 1 cm or more. In particular, in a BNCT ray source using p-Li, since main energy is in the vicinity of 0.1 to 0.5 MeV, there is no obstacle in measurement as long as the filter thickness is 1 cm or more.

Meanwhile, when the thickness is large, the correction factor is stable. However, for example, when using the filter 11 of 5 cm thickness, the diameter of the filter 11 is at least 10 cm or more, and there is a risk of distortion of the neutron and gamma-ray fields. Therefore, the thickness is preferably set to 2 cm or less. This also applies to the case of using an activation foil and a small detector.

Next, since the contribution of the γ-rays secondarily generated is extremely smaller than the components of the gamma-rays of the measuring field, it is considered that there is no problem on the measurement accuracy, without taking the neutron-induced gamma-ray dose (Dnγ) into consideration. Thus, the following formula is obtained.

Dnγ (lead)=Dnγ≈0

From the above formulas, D−Dlead=Dγ−ξDγ=(1−ξ) Dγ is obtained, and from the definition of formula (4),

Dγ=η·(D−Dlead) is obtained. In the BNCT, in the case of a p-Li-based beam source, since the main energy is in the vicinity of 0.1 to 0.5 MeV, the correction factor η≈2 is predictable with sufficient accuracy by calculation.

In other words, as a result, it is possible to measure the dose of gamma-rays, by subtracting the radiation dose measured by the first detector 1 from the radiation dose measured by the second detector 2. Thus, it is possible to measure the dose of gamma-rays in a mixed field of neutrons and gamma-rays with the simple and inexpensive configuration.

[Modified Example of Filter]

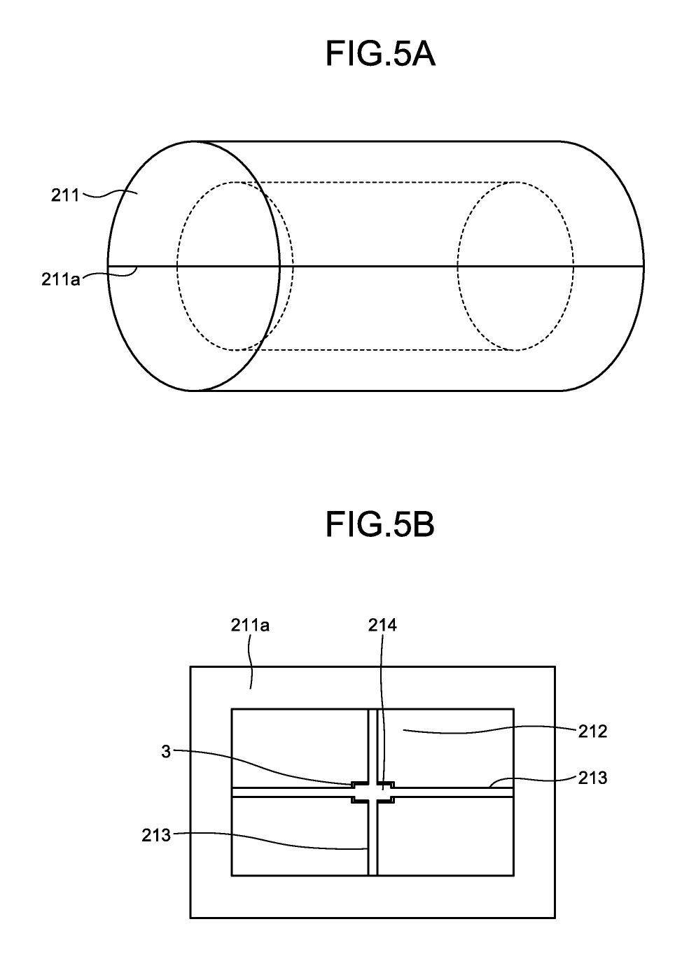

FIGS. 5A and 5B are block diagrams illustrating a modified example of the first detector. FIG. 5A is a perspective view of a modified example of the first detector. FIG. 5B is a plan view of a modified example of the second detector. A filter 211 is a lead casting, has a cylindrical shape as a whole, and has a bisected structure in an axial direction as described above. A divided end surface 211a of the filter 211 has a stepped shape to prevent gamma-rays and neutrons from escaping in the radial direction from the center in a state of a combined tubular body. The divided end surface 211a is provided with a support member 212 that is capable of holding the glass dosimeter 3 at the axial center and at the circumferential center. The support member 212 is made up of arms 213 that extend toward the center from the divided end surface 211a, and has a configuration in which an adhesive tape or the like is provided in a fixing portion 214 that holds the glass dosimeter 3. The support member 212 is made up of a planar thin plate that is made of a material in which the property of absorbing neutrons and gamma-rays is low. Even with this configuration may be used as the first detector 1.

[Examination Example of Filter Thickness]

The thickness of the filter 11 was examined by the Flat response analysis. The attenuation of neutrons and gamma-rays has the energy dependence. Although a sensitivity analysis of the energy is possible, in practical applications, since the attenuation is highly dependent on the spectrum of the field, the effect is evaluation of the correction factor, while checking the spectrum in each field. However, since the relevant method is complicated, hereinafter, a tendency of approximate exclusion of spectral dependence of the field was obtained. Specifically, on the assumption that the spectrums of neutrons and gamma-rays are uniform (neutrons are constant per lethargy, gamma-rays are constant per MeV, and a total integrated value is standardized), and the attenuation term or the like is obtained by integration, an integration tendency was shown.

[Attenuation Error of Neutron]

The residual quantity (in which the attenuation is expressed by %) of drawing of Dn (see formula (2)) using the Flat response analysis is as follows. This corresponds to the quantity obtained by integrating the condition illustrated in FIG. 3 by assuming a certain spectrum (Flat spectrum).

When the filter thickness is 1 cm (10 mm), the neutron attenuation is 6.6%. When the filter thickness is 2 cm (20 mm), the neutron attenuation is 8.5%. When the filter thickness is 5 cm (50 mm), the neutron attenuation is 11.1%. In this way, when the thickness of the filter 11 increases, the remainder of the drawing increases. Since it is uncertain how the influence of the neutrons affects on the gamma-ray dose conversion of a dosimeter reader, it is important to reduce the neutron attenuation as much as possible. Therefore, it is necessary to reduce the thickness of the filter 11 as much as possible.

[Contribution of Dnγ]

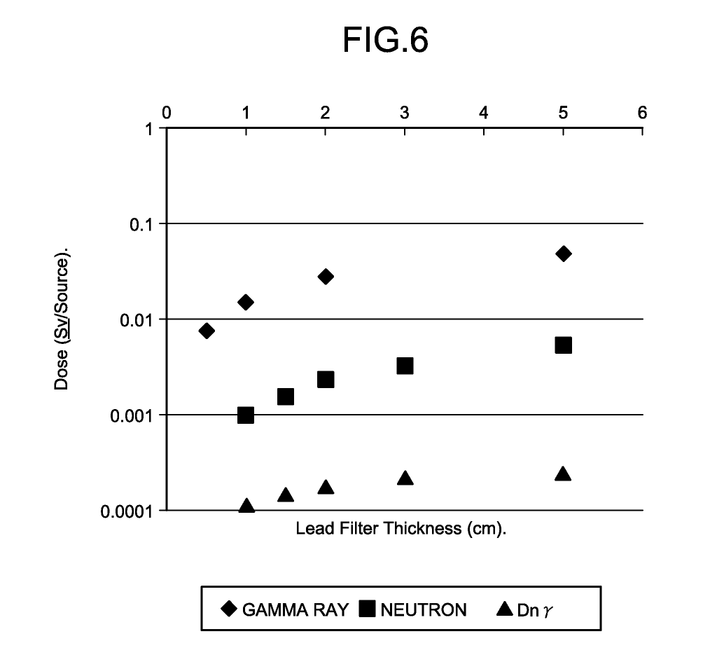

FIG. 6 is a graph illustrating a subtraction result (Sv value per source) of the filter presence or absence of the dose D of the mixed field using the Flat response analysis. As illustrated in FIG. 6, since the components of the gamma-rays are large, it is understood that the subtraction method can basically be usable. Further, it is understood that Dnγ can be ignored, since its contribution is sufficiently small.

[Correction Factor η of Gamma-ray]

The correction factor η using the Flat response analysis is as follows:

When the filter thickness is 0.5 cm (5 mm), the correction factor η is 7.8. When the filter thickness is 1 cm (10 mm), the correction factor η is 3.85. When the filter thickness is 2 cm (20 mm), the correction factor η is 2.08. When the filter thickness is 5 cm (50 mm), the correction factor η is 1.20. This result indicates that it would be better to increase the thickness of the filter 11 as much as possible. If the filter thickness is small, the correction factor increases, so that the statistical error significantly propagates. However, in the actual BNCT neutron field using the p-Li, since the spectrum of gamma-rays has a peak in the vicinity of 0.1 to 0.5 MeV, the correction factor is further reduced.

The result of the Flat response analysis showed that the attenuation error of neutrons would be better in the case of the thin filter thickness. However, since the gamma-ray dose conversion effect of the neutron dose is unknown, it would be better if this effect is small (the filter 11 is thin) as much as possible. Further, from the viewpoint of the attenuation correction factor of the gamma-rays, it is considered that it would be better if the filter thickness is thick. Furthermore, when the filter thickness is smaller than 1 cm, the correction factor considerably increases and is not desirable. From the above, by the use of the filter 11 of 1 cm, it is possible to accurately determine the dose of gamma-rays using the glass dosimeter 3 in a mixed field of neutrons and gamma-rays.

### REFERENCE SIGNS LIST

100 Gamma-Ray Measurement Device

1 First Detector

2 Second Detector

3 Glass Dosimeter

11 Filter

12 Support Member

1. A gamma-ray measurement device comprising:
a first detector which is disposed around a radiation dosimeter that is the same as a radiation dosimeter constituting a second detector used together, and is formed of lead or lead alloy, wherein the first detector is made up of a filter in which the thickness is determined such that an attenuation of neutrons and a correction factor of gamma-rays are within an allowable range in the measurement of gamma rays.

2. The gamma-ray measurement device according to claim 1, wherein the thickness of the filter is 2 cm or less and 1 cm or more in terms of pure lead.

3. The gamma-ray measurement device according to claim 1, wherein the filter further is a substantially hollow spherical body or a substantially cylindrical body having a uniform thickness in which a glass dosimeter is disposed in a center.

4. The gamma-ray measurement device according to claim 3, further comprising:
a support member configured to support the glass dosimeter at a predetermined position therein.

5. A gamma-ray measurement method comprising:
placing the first detector of the gamma-ray measurement device according to claim 1, and the second detector made up of the same radiation dosimeter as the radiation dosimeter used in the first detector in a mixed field of neutrons and gamma-ray; and
thereafter, determining the dose of gamma-rays based on the remaining dose as the attenuation of the dose of gamma-rays, by subtracting the dose measured by the radiation dosimeter of the first detector from the dose measured by the radiation dosimeter of the second detector.

6. The gamma-ray measurement device according to claim 2, wherein the filter further is a substantially hollow spherical body or a substantially cylindrical body having a uniform thickness in which a glass dosimeter is disposed in a center.

7. The gamma-ray measurement device according to claim 6, further comprising:
a support member configured to support the glass dosimeter at a predetermined position therein.
